(19) United States
(12) Patent Application Publication
(10) Pub. No.: US 2026/0350191 A1
(43) Pub. Date: Nov. 5, 2026

(54) SYSTEM AND METHOD FOR ANONYMIZATION BY TRANSFORMING INPUT DATA FOR COMPARISON AND ANALYSIS

(71) Applicant: DV ANALYTICS AB, Täby (SE)

(72) Inventors: Wojciech CHACHÓLSKI, Täby (SE); Ryan RAMANUJAM, Fort Mill, SC (US)

(21) Appl. No.: 19/114,124

(22) PCT Filed: Sep. 22, 2023
(86) PCT No.: PCT/EP2023/076280

§ 371 Date: Mar. 21, 2025

(30) Foreign Application Priority Data
Nov. 9, 2022 (EP) 22206374.5

(51) Int. Cl. G06F 21/60

(52) U.S. Cl. CPC G06F 21/602

(57) ABSTRACT

A system configured for transformation and anonymization of data, and comparison and analysis, includes: an input interface for obtaining data; a processing unit configured to carry out a method comprising: obtaining the data and transformation of the data into a dataset; generating a reference object; filtering the points of the dataset by applying a distance filter function of the reference object; building, for each data point of the dataset, n stable ranks by sampling m sample points of the reference object; generating, for each data point of the dataset, an average stable rank by averaging each n stable ranks; applying distance metrics to the output stable ranks for comparisons and analysis; using output signatures for data analytics and machine learning models; using outputs signatures for comparison of data across various conditions; configuring machine learning models.

### CROSS-REFERENCE TO RELATED APPLICATIONS

The present application is the national phase entry of International Patent Application PCT/EP 2023/076280, filed Sep. 22, 2023, which claims priority to U.S. Provisional Patent Application No. 63/376,837, filed Sep. 23, 2022, and European Patent Application 22206374.5, filed Nov. 9, 2022, the entire contents of which are hereby incorporated by reference.

### BACKGROUND

Transformation of data is an essential tool in many technical fields, for example in order to safely and accurately compare input data, such as measurement data, and analyze it with respect to various outcomes.

Data encryption has for long been an essential step in the securing of confidential information. Typically, unencrypted plaintext data is translated into encrypted ciphertext data in a predetermined way. A user may retrieve the plaintext data from the ciphertext data through the use of a decryption key. There are several different encryption methods, each developed with different security needs in mind. The two main types of data encryption are asymmetric encryption (e.g. RSA and PKI) and symmetric encryption (e.g. DES and AES).

Data encryption serves an important role in the enablement of sharing of confidential information, and in order to prevent third parties from getting access to the confidential information.

For particular applications, there may be instances wherein an owner of confidential information wants to share only some of the data with another party, or a representation of the data which is not identifiable. This may for example be the case in the context of medical data, wherein sharing of medical data (e.g. clinical trial data) with a third party may require making part of the data inaccessible to the third party, due to for example confidentiality reasons.

For example, a pharmaceutical company may have a dataset containing experimental gene expression data generated from patients with a given disease. Another company might have conducted a similar experiment on a different group of patients, and may thus have obtained a similar dataset. Through de-identification and/or anonymization of the data, each respective company can ensure that the raw data remain confidential, and thereby the companies can share the transformed parts of the data with each other and/or third parties.

Sharing of the anonymized data would for example allow for a comparison aimed at determining if there are patient groups overlap with the category or phenotype of interest (i.e. disease state) and analytical methods could be used to determine subgroups of these data, based on for example geometry, which have high enrichment of individuals with that particular phenotype. Based on this, the company(s) could gain information about similar patients across two diseases, which could for example lead to new groupings in clinical trials and/or drug repurposing. There are similar applications possible in other industries, such as finance, insurance, banking, fraud detection, medical, industrial, advertising, personal data, etc. where data might be shared between parties or via a central repository such as a data broker.

Data anonymization may be seen as a method aimed at encrypting or otherwise transforming certain features of the data, or possibly the entire dataset.

Data anonymization has been defined as a “process by which personal data is altered in such a way that the original data can no longer be identified directly or indirectly, either by the data controller alone or in collaboration with any other party.”

Conventional approaches for de-identification and anonymization of data typically relies on encryption, one-way/hash transformations, tokenization, or federated learning. This is also true for US20180004978 disclosing a method for anonymizing personal information during a payment transaction. These methods of prior art all have several weaknesses, including the fact that they do not retain relational information in the data and that they impose limitations to the downstream analysis. In addition, the methods of the prior art require that the data is uniform in preparation and have matching elements. Thus, there is a strong need to overcome these drawbacks with the methods of the prior art.

Agerberg et al. “Data, geometry and homology”, arXiv: 2203.08306, Mar. 15, 2022 discloses that homology-based invariants can be used to characterize the geometry of datasets and thereby gain some understanding of the processes generating those datasets.

### SUMMARY

There exists a need for transforming input data, for example into signatures, for providing de-identification and/or anonymization of data. Typically, wherein the relational information of the data is retained, and which does not require that the input data is uniform in preparation or has matching elements.

As disclosed herein, this can be achieved by a system configured for anonymizing and transforming input data into signatures, the system comprising:
an input interface configured for obtaining data;
a processing unit configured for carrying out a method of de-identification and anonymization of input data, the method comprising:
   i. obtaining the input data by the input interface;
   ii. transforming the input data into a subset D of an ambient distance space U, which may be a subset of the set of sequences of n real numbers Rⁿ with the Euclidean distance;
   iii. generating a reference object, described by a dataset T, wherein the dataset T is a subset of the ambient distance space U;
   iv. generating, for each point x of the dataset D, a filter function ƒₓ on the reference object T;
   v. selecting a set of distributions encoding geometrical aspects of the reference object T;
   vi. sampling, for each point x of the dataset D, a predetermined number of sample points of the dataset T according to probabilities given by the values of the selected distribution(s) evaluated on the filter function ƒₓ;
   vii. selecting a clustering method as a base parameter for generating zero degree homology stable ranks;
   viii. selecting a homology degree and, for each point x of the dataset D and for each distribution and clustering method, take the average associated homology stable rank which results in a sequence of stable ranks for each data point x;
thereby obtaining fully anonymous signatures of the input data.

It should be noted that the presently disclosed systems and methods relate to one-way or federated approaches, in which the input data is used in the method but never revealed. These are clearly distinct from approaches which merely encrypt input data (e.g. raw data) and later decrypt said data.

The presently disclosed system allows for transformation, such as de-identification and anonymization, of practically any type of input data in order to obtain transformed data, that is a signature of the input data. Importantly, the system is arranged such that the transformed data retains its relational information, thus enabling accurate downstream analysis of the transformed data.

The selection of a set of distributions encoding geometrical aspects of the reference object T (step v.), is one of the novel aspects of the present disclosure. The selection, such as addition, of a set of non-random distributions is noteworthy. Moreover, these distributions are typically chosen based on exploring the geometry produced by various filter functions on both the data and the reference object. The use of multiple distributions has further implications downstream during the sampling procedure, which can use these probabilities to construct the resultant transformed functions. An additional consequence of selecting a set of distributions is that the reliance on a particular data point has been reduced. Thus, the effect of missing or erroneous data is minimized. This results in signatures of an input data that can anonymously be compared with other signatures, and wherein the need for data matching has been eliminated, as also disclosed elsewhere herein.

The output data can be considered de-identified and anonymized. Alternatively, or additionally, the output data may be a signature that represents the input data. Such signatures may be used for example in the comparison of medical and/or biological data. As an example, tumor cell line transcription data (gene expression or RNA-seq) can be used to build a molecular signature of that particular tumor type which may then be shared or used for downstream analysis.

Further, the output data can be completely de-anonymized without an ability to retrieve the original input data. Thus, the method may be arranged such that it is possible to readily distribute anonymized output data to third parties without risk of exposing the confidential information of the original input data.

Another advantage of the disclosed system is that it does not require centralization for joint processing of data from different sources, nor do the different datasets have to be uniform in preparation or have matching elements. Participants do not have to identify the variables contained in the dataset, and with minor considerations can shuffle their order, thereby obfuscating it even before the anonymization of the method. Thus, the system allows for a highly versatile way of comparing and/or processing of different confidential input data.

In a second aspect, the present disclosure relates to a computer-implemented method of anonymizing and transforming input data to signatures, the method comprising:
i. obtaining the input data;
ii. transforming the input data into a subset D of an ambient distance space U, which may be a subset of the set of sequences of n real numbers Rⁿ with the Euclidean distance;
iii. generating a reference object, described by a dataset T, wherein the dataset T is a subset of the ambient distance space U;
iv. generating, for each point x of the dataset D, a filter function ƒₓ on the reference object T;
v. selecting a set of distributions encoding geometrical aspects of the reference object T;
vi. sampling, for each point x of the dataset D, a predetermined number of sample points of the dataset T according to probabilities given by the values of the selected distribution(s) evaluated on the filter function ƒₓ;
vii. selecting a clustering method as a base parameter for generating zero degree homology stable ranks;
viii. selecting a homology degree and, for each point x of the dataset D and for each distribution and clustering method, take the average associated homology stable rank which results in a sequence of stable ranks for each data point x;
thereby obtaining fully anonymous signatures of the input data.

In a further aspect, the present disclosure relates to a computer program product that comprises instructions which, when the program is executed by a computer, cause the computer to carry out the steps of the computer-implemented method of anonymizing and transforming input data to signatures, as disclosed elsewhere herein.

### DESCRIPTION OF THE DRAWINGS

In the following embodiment and examples will be described in greater detail with reference to the accompanying drawings:

FIG. 1 shows a flow chart of an embodiment of a method of anonymizing and transforming input data to signatures, as disclosed herein,

FIG. 2 shows a flow chart of an embodiment of a method of anonymizing and transforming input data to, as disclosed herein,

FIG. 3 shows an input dataset according to an embodiment of the presently disclosed method,

FIG. 4 shows signatures generated from the input dataset of FIG. 3, according to an embodiment of the presently disclosed method.

### DETAILED DESCRIPTION

Transformation and/or anonymization of data is an essential tool in many technical fields, for example in order to safely and accurately compare input data, such as measurement data.

As an example, tumor cell line transcription data (gene expression or RNA-seq) can be used to build a molecular signature of that particular tumor type which may then be shared or used for downstream analysis.

Another example relates to how, every year, many clinical trials fail due to lack of efficacy. If the companies that carry out these trials were able to find subsets of patients who respond to the therapy, they could re-submit this to the regulating authorities and might be able to continue the clinical trials. By allowing third parties to analyze and share such data, new insights of the data could potentially be identified across disease areas.

There are similar applications possible in other industries, such as finance, insurance, banking, fraud detection, medical, industrial, advertising, personal data, etc. where data might be shared between parties or via a central repository such as a data broker, and wherein there is a requirement of anonymization of the data.

It is clear that a distinction can be drawn between methods and systems which encrypt input data (e.g. raw data) and later decrypt said data and methods and system that are one-way or federated, in which the input data is used but never revealed and/or without a possibility of being retrieved. The presently disclosed methods and systems belong to the second group, which is typically arranged such that input data can be confidential and wherein for example recovery or reverse-engineering of that data is impossible. A signature of the data, as used herein, refers to a set of transformed data which retains some aspects and/or features of the original dataset but from which the original data cannot be extracted.

In particular, two companies comparing their results in failed clinical trials may discover that a similar subset of patients with another disease might benefit from the therapy. This could lead to a new disease indication and allow the drug to be given an abbreviated trial or fast-track status. Many approved therapies are currently used for an indication other than that in the original trial, sildenafil being a typical example. Thus, there is a strong motivation to identify such new disease indications in the event of, for example, failed clinical trials.

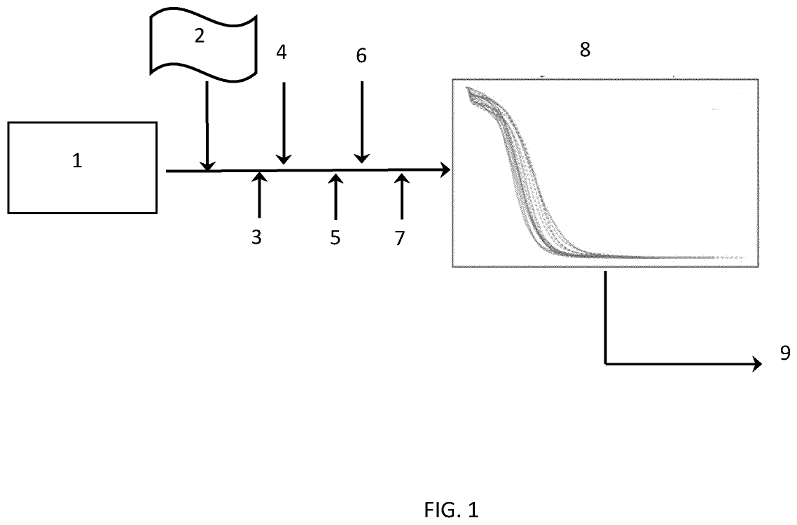

FIG. 1 shows input data (1), also referred to herein as a input dataset, that typically is, or has been, retrieved through an input means of a system configured for anonymizing and transforming input data to signatures, and/or for de-identification and anonymization of input data.

The input data may for example be medical data, biological data and/or financial data. For medical data, the input data could be measurement data and/or outcome data of a clinical trial. Biological data could for example comprise measurement data from biological measurements/experiments. The biological data could comprise information from gene expression, RNA sequencing, proteomics, metabolomics, genomics, clinical or personal health information, other “omics”, and/or any thereto related information.

The method of the present disclosure is typically arranged such that it can be carried out irrespective of whether identical parameters of the input data are known or not. Hence, different input data may be transformed irrespective of what parameters are known about each individual input data. The transformed data (i.e. the output data) may also be referred to as signatures of the input data. These signatures may be compared even though the known parameters of the individual input data may differ.

The signatures have typically been obtained by a method for anonymizing and transforming input data to signatures, and/or a method for de-identification and anonymization of input data.

The signatures can be used to, for example, identify types, subtypes, or important aspects of the input data. For instance when concerning biological samples or individuals. The input data may be compared either within and/or across data sets. As an example, tumor cell line transcription data (gene expression or RNA-seq) can be used to build a molecular signature of that particular tumor type which may then be shared or used for downstream analysis.

The subsequent analysis retains embedded geometrical information which may then be correlated to various outcomes, such as drug response for the various cell lines. These signatures can then be directly compared, including when the signatures have been obtained by transformation of different datasets, including datasets that do not have the same exact set of variables.

Thus, signatures may be generated from a wide range of input data. For example, the input data may be omics data types, such as genomics, proteomics, metabolomics, or other clinical or experimental data of individuals or biological samples. The generation of signatures allows for comparison and analysis of input data from different datasets, for example wherein the datasets have different variables, and/or wherein there is a need for de-identification and/or anonymization.

The input data may for example be distributed in an array or n-dimensional matrix. Each row could correspond to one patient, with either a single measurement time or followed longitudinally through the trial. Multiple rows might be used in the latter case of time series of a patient's measurements.

The input data (1) is thereafter processed in order to obtain transformed data, such as a de-identified and/or fully anonymous representation of the dataset D. Typically, as in the method and/or system of the present disclosure, the input data is modified by the use of a reference object (2), a filter function (3), a set of distributions (4), a sampling step (5), the extraction of homology stable ranks (6), an averaging step (7). The end product is typically either one or a plurality of stable ranks (8). The stable ranks are anonymized representations of the data encoding some aspects of its geometry. Alternatively or additionally, the stable ranks can correspond to subsets of data points (including singletons) of the dataset D, wherein the dataset D is derived from the input data.

Unlike most other methods for de-identification and/or anonymization, the present method enables downstream processing (9) of the anonymized data set, for example the comparison of multiple anonymized datasets by a machine learning model, e.g. in order to identify similarities and/or overlaps between the outputs of the method.

This may enable companies to collaborate with other entities using data they consider to be valuable proprietary information, by sharing only de-identified and/or anonymized information.

The output (i.e. output data) of the method of the present disclosure can be considered to be anonymized signatures of the input data. However, although it is a one-way transformation, its outcomes retain some geometrical features of the data points, thus it allows for data processing of the output data, such as the comparison of input data that has been anonymized by the presently disclosed method.

The form of the output data typically makes it suitable as an input of a wide range of data analytic and machine learning methods. The retained geometrical features typically enable the use of the output data to make conclusions about relationships between the data points of the original dataset.

The system of the present disclosure, and the related method, thus may package relevant geometrical information of the input data, often crucial for its analysis, in a way that is not reversible.

The system of the present disclosure and the related methods may allow for anonymizing data, typically by removing any possibility of re-identifying the original input data in any way.

Further, the system of the present disclosure and the related methods may allow for direct comparison of transformed data, even when the number of features/columns between datasets differs or is ordered differently, or is not uniform between datasets.

Yet further, the system of the present disclosure and the related methods may allow for the output data (8) to have a format, which makes them suitable for further data processing, e.g. comparison of multiple output data in order to find similarities and/or overlaps. The format may for example be such that they are suitable as inputs for data analytic and/or machine learning methods.

Even further, the system of the present disclosure and the related methods may allow for transforming, such as anonymization and/or de-identification of, input data while it allows for retention of some properties of the geometrical information of the original data. Thus, it may give the possibility of making conclusions about the original data based on the processing/analysis of the transformed data, called signatures.

Further, the system of the present disclosure and the related methods may enable analysis of the output signatures, in order to gain information about the structure of the data such as classification or geometric partitioning, as well as overlap or similarity.

The method typically relies on the processing of input data. Input data may be provided in various formats. Commonly, input data is a collection of points in a multi-dimensional space. Typically, as such, the input data may be referred to as a “point cloud”.

An alternative representation of data is as a distance object, which typically represents the distances given by a choice of a metric or distance similarity on the set of data points.

Additionally, the method of the present disclosure typically involves a filter function. The filter function may be arranged to assign to each point of the data a function on a reference object. An example could be a real-valued function given by distances of a data point to the points of the reference object. Another example could be a real-value function given by geometrical projections onto a chosen vector field.

Lastly, we define a set of parameters that guide the process. These parameters are typically comprised of for example the homology in question, i.e. H₀ or H₁ (or higher homology), the distance metrics used, the clustering method(s), the sampling procedure, the reference object and the filter function.

The method is typically arranged such that a sampling procedure is carried out in order to build one or more stable ranks for each data point x.

The method typically comprises a step of selecting a distribution. The distribution may for example be a uniform distribution, a normal distribution, or any distribution such as those defined by a piecewise constant function. The distribution is used to sample points based on the probabilities obtained from applying the chosen distribution to the filter function. The sample points are thereafter used to build averaged stable ranks, which typically lowers the deviation and aids in denoising.

In the end, n stable ranks are typically constructed by sampling m points from the reference object, based on the values of the chosen distribution on the filter function. Based on the chosen parameters, the n averaged stable ranks are assigned to each point of the datasets, or a subset, or the entire dataset, which encode their geometrical relation with respect to the reference object.

Stable ranks are topological invariants that have been previously described, among others Scolamiero 2017, Riihimaki 2018 and Agerberg 2021. These stable ranks can be constructed for each and every point in the dataset multiple times based on the product of parameter choices.

Thus, a large number of stable ranks using this guided process can be created to represent each data point, and there is at least one stable rank constructed for each point. These stable rank outputs completely anonymize the data, meaning there is no method to recover the original data coordinates.

A further benefit of the present disclosure is that these outputs can be used as inputs for various data analytic methods, such as machine learning, statistics, AI, etc. This is due to a convenient and computable variety of distances on the outputs such as integral distance, interleaving distance, or any other metric to represent distances between stable ranks.

In one embodiment of the present disclosure, the dataset D comprises or consists of a collection of data points in a distance space, which may be the Euclidean space Rⁿ. The input data is thus typically first obtained by an input interface, and thereafter the system is arranged such that the input data is transformed and/or modified into a subset D of an ambient distance space U.

The reference object may be an internal reference object that is a subset of the dataset D. Alternatively or additionally, the reference object may be an external reference object that is a subset of U, but not a subset of D.

A reference object is typically defined in relation to the input data/point cloud. The reference object may be the data or one of its subsets, in which case it is called internal. It may alternatively be any subset of the ambient space U in which case it is called external. In case the ambient space is the Euclidean space, the reference object may be, but is not limited to, a set of points sampled from a circle or another geometrical object, or some known reference data reflecting prior knowledge.

Typically, an internal reference object is a subset of D that corresponds to certain choices. These choices may be made by selecting a portion of the data based on external information, such as categorization that originates from data not in D. They may correspond to given clinical observation(s) for biological data, or to a given type of transaction(s) for financial data, or to being a certain distance from a given point in the data (the center of mass for instance), or to points in the data that satisfies some geometrical constraints.

An internal reference object may be the dataset D itself.

The stable ranks with respect to internal reference objects encode internal geometry of the points of the dataset.

An external reference object, on the other hand, is a subset of U that is not a subset of D. The external reference object may for example be an outcome of another experiment, or a set of transactions, or a given subset of U.

In one example, the internal reference object is a subset of D corresponding to a predetermined type of category of points of the data.

In one embodiment of the present disclosure, the reference object is an external reference object, which is a subset of the ambient distance space U given by a dataset D₂, which is not a subset of D.

However, in other embodiments the reference object may comprise both internal and external reference objects.

A filter function is a function that maps each point x of the dataset to a function fₓ on the reference object. It may be given by the distances of points in the reference object to the data points. In this example the filter function fₓ on the reference object T is arranged to produce a distance between points in the reference object T and the data point x.

Alternatively, or additionally, the filter function fₓ on the reference object may be given by a geometrical projection along a vector field on the product between the dataset and the reference object.

In one embodiment of the present disclosure, the ambient distance space U is selected from the space of n sequences of real, and/or complex, numbers Rⁿ, such as wherein the distance is given by any one of Euclidean, Chebyshev, Minkowski, cosine, or other distance. Thus, the ambient distance space U may be selected from the space of n sequences of real numbers with the Euclidean distance. Additionally, or alternatively, the ambient distance space U may be selected from the space of n sequences of real numbers and/or complex numbers, preferably wherein the distance is given by Euclidean, Chebyshev, Minkowski, cosine and/or any other distance.

The system of the present disclosure, and the related methods may comprise a step of selecting a set of distributions, or alternatively a single distribution encoding geometrical aspects of the reference object T, i.e., step v. of the method.

Typically, for each point x in the dataset D, the reference object is sampled according to probabilities given by the chosen distribution(s) and the filter function.

Each point of the data D may give a sampling of the reference object. This sampling may thus reflect the geometry of the points of the reference object that satisfy geometrical constraints imposed by the position of a given data point in relation to the reference object and the chosen filter and distribution.

Thus, for each data point x, the method may be arranged such that a set of the samplings are obtained. For example, for each data point the method may result in 100 samplings of 10 points, for each filter and distribution.

In one embodiment of the present disclosure, the set of distributions comprise one or more of a uniform distribution, a uniform distribution supported on a specified domain range, a normal distribution and/or any distribution including those that can be defined by a piecewise linear function and/or a combination thereof.

The set of distributions used often comprises multiple distributions. The sampling may in such instances comprise a round of sampling for each distribution of the set of distributions, and wherein each round of sampling comprises, for each point x of the dataset D, sampling by obtaining data points according to the probabilities determined by each respective distribution applied to the filter function fₓ.

In one embodiment of the present disclosure, the sampling enables averaging of the resultant stable ranks, thereby decreasing deviation and extracting more relevant and statistically useful geometrical information.

Thus, the system of the present disclosure, and the related methods, typically include a step in which a number of average stable ranks are generated for every point x in the dataset D. The averaging process may reflect the samplings of the reference object obtained from the chosen filter function and distribution. Thus, each data point of the dataset D may be encoded by a collection of averaged stable ranks which encode geometrical properties of that data point relative to the reference object.

In one embodiment of the present disclosure, the coordinates of the point(s) of the original dataset D cannot be retrieved from the obtained stable ranks.

In a further aspect, the present disclosure relates to a computer implemented method for transforming input data, in order to obtain transformed data. The transformed data may be a de-identified and/or fully anonymous representation of a dataset D. The transformed data may further be referred to as signatures of the input data. Thus, the method may be a method of anonymizing and transforming input data to signatures. The transformed data typically allows for subsequent analysis. The presently disclosed method typically comprising:
i. obtaining the input data;
ii. transforming the input data into a subset D of an ambient distance space U, which may consist of a subset of the set of sequences of n real numbers Rⁿ with the Euclidean distance;
iii. generating a reference object, described by a dataset T, wherein the dataset T is a subset of the ambient distance space U;
iv. generating, for each point x of the dataset D, a filter function fₓ on the reference object T;
v. selecting a set of distributions encoding geometrical aspects of the reference object T;
vi. sampling, for each point x of the dataset D, a predetermined number of sample points of the dataset T according to probabilities given by the values of the selected distribution(s) evaluated on the filter function fₓ;
vii. selecting a clustering method as a base parameter for generating zero degree homology stable ranks; and
viii selecting a homology degree and, for each point x of the dataset D and for each distribution and clustering method, take the average associated homology stable rank which results in a sequence of stable ranks for each data point x;
   thereby obtaining transformed data that is a representation of the dataset D, the transformed data may for example be de-identified and fully anonymous and/or referred to as a signature of the input data, for example, the transformed data may be fully anonymous signatures of the input dataset.

As mentioned elsewhere herein, one of the advantages of the present disclosure compared to prior art methods is typically the ability of using the output (i.e. the output data) of the method or following processing of the system, as disclosed herein, for conducting analysis of the data.

The selection of a set of distributions encoding geometrical aspects of the reference object T (step v.), is one of the novel aspects of the present disclosure. The selection, such as addition, of a set of non-random distributions is noteworthy. Moreover, these distributions are typically chosen based on exploring the geometry produced by various filter functions on both the data and the reference object. The use of multiple distributions has further implications downstream during the sampling procedure, which can use these probabilities to construct the resultant transformed functions. An additional consequence of selecting a set of distributions is that the reliance on a particular data point has been reduced. Thus, the effect of missing or erroneous data is minimized. This results in signatures of an input data that can anonymously be compared with other signatures, and wherein the need for data matching has been eliminated, as also disclosed elsewhere herein.

In one embodiment of the present disclosure, the method comprises a step of providing the transformed data, such as de-identified and anonymized data, in a form suitable for machine learning modeling and analysis. Thus, although the dataset has been transformed, such as anonymized and de-identified, the outcomes based on the present disclosure may be used in order to obtain new insights.

The transformed data may represent signatures of the input data. The signatures might be used to identify types, subtypes/subgroups, class membership, correlation with outcomes/variables, and/or important aspects of the input data. These may be in an unsupervised manner, or with respect to various outcomes of the data, i.e. additional characteristics which are measured and are useful for creating classes or decision making. This may include various categories, i.e. patients or controls, some output information on disease status, phenotype, clinical categories, lab values, personal/clinical characteristics, etc. Data from biological samples, individuals, or from other processes may be compared either within and or across data sets using these (transformed) signatures.

As a specific example, tumor cell line transcription data (such as gene expression or RNA-seq) can be used to build a molecular signature of that particular tumor type which may then be shared or used for downstream analysis. The subsequent analysis retains embedded geometrical information which may then be correlated to various outcomes, such as drug responses for the various cell lines.

The method may for example comprise a step of providing multiple sets of transformed data, such as de-identified and anonymized data which can be considered signatures, to a machine learning model. Preferably, wherein the machine learning model is configured for comparison of the transformed data sets, such as the de-identified and anonymized signatures. Thus, although the datasets have been transformed, they may be used in order to obtain new insights based on the information embedded from the considered datasets.

In one embodiment of the present disclosure, the dataset D comprises or consists of a collection of data points in a distance space, which may be the Euclidean space Rⁿ.

In one embodiment of the present disclosure, the reference object is an internal reference object that is a subset of the dataset D.

In one embodiment of the present disclosure, the internal reference object is a subset of D corresponding to a predetermined type of category of data.

In one embodiment of the present disclosure, the category of data for the reference object selection may be some group which may include some clinical observation(s) and/or some other observation from the data.

In one embodiment of the present disclosure, the reference object is an external reference object, which is a subset of the ambient distance space U given by a dataset D₂, which is not a subset of D.

In one embodiment of the present disclosure, the ambient distance space U could be selected from the space of n sequences of real, and/or complex, numbers Rⁿ, such as wherein the distance is given by any one of Euclidean, Chebyshev, Minkowski, cosine, or another distance.

Thus, the ambient distance space U may be selected from the space of n sequences of real numbers with the Euclidean distance. Additionally, or alternatively, the ambient distance space U may be selected from the space of n sequences of real numbers and/or complex numbers, preferably wherein the distance is given by Euclidean, Chebyshev, Minkowski, cosine and/or any other distance.

The method typically comprises a step of generating, for each point x of the dataset D, a filter function fₓ on the reference object T. The filter function fₓ on the reference object may for example be given by a geometrical projection along a vector field on the product between the dataset and the reference object.

In one embodiment of the present disclosure, the filter function of the reference object is a projection function, with each value given by the scalar product of the vector between the original point x and a point of the reference object T with a predetermined vector field on the product of the reference object and the data.

In one embodiment of the present disclosure, the filter function of the internal reference object is a distance function and/or a projection function.

In one embodiment of the present disclosure, the set of distributions comprises one or more of a uniform distribution, a uniform distribution supported on a specified domain range, a normal distribution and/or any distribution including those that can be defined by a piecewise linear function and/or a combination thereof.

In one embodiment of the present disclosure, for each point x of the dataset D the sampling is obtained according to probabilities determined by each distribution, of the set of distributions, applied to the filter function fₓ.

The method typically comprises a step of selecting a homology degree, wherein the degree is any natural number. For instance, the considered homology degree may for example be 0, 1 or 2 and the corresponding homologies are denoted as H₀, H₁ and H₂.

In one embodiment of the present disclosure, the set of distributions comprises multiple distributions, and wherein the sampling comprises a round of sampling for each distribution of the set of distributions, and wherein each round of sampling comprises, for each point x of the dataset D, sampling by obtaining data points according to the probabilities determined by each respective distribution applied to the filter function fₓ.

The one or more distributions of the set of distributions may for example be uniform, normal, or any distribution including those defined by a piecewise constant function. Each distribution is typically used to sample points from the reference object according to the values of the filter function. This leads to at least one stable rank for each point of the data, and averaged by considered stable ranks of multiple samplings.

These stable ranks are then constructed for each and every point in the dataset, and this can be conducted multiple times based on the parameter choices.

Thus, typically a large number of stable ranks using this guided process can be created to represent each data point, and there is at least one stable rank constructed for each data point. The stable rank outputs, based on one or more reference objects, are typically completely anonymized, meaning there is no method to recover the original data coordinates. However, the range of stable ranks constructed for each point in the dataset typically allows for comparison and analysis methods. Thus, the stable ranks and/or the averaged stable ranks, from different input data, may be used in order to compare the different input data, e.g. by identifying overlaps, similarities, trends, and/or differences.

In one embodiment of the present disclosure, each data point of the dataset D is encoded by its geometrical properties via the generated average stable ranks.

In one embodiment of the present disclosure, the method comprises a step of applying distance metric(s) to the series of averaged stable ranks (i.e. the output data), for further analysis. The distance metrics may for example be integral distance, interleaving distance, or any other distance between stable ranks.

In one embodiment of the present disclosure, the coordinates of the point(s) of the original dataset D cannot be retrieved from the obtained stable ranks.

In a further aspect, the present disclosure relates to a computer program product that comprises instructions which, when the program is executed by a computer, cause the computer to carry out the steps of the computer-implemented method for transforming, such as de-identification and anonymization of, input data as disclosed elsewhere herein.

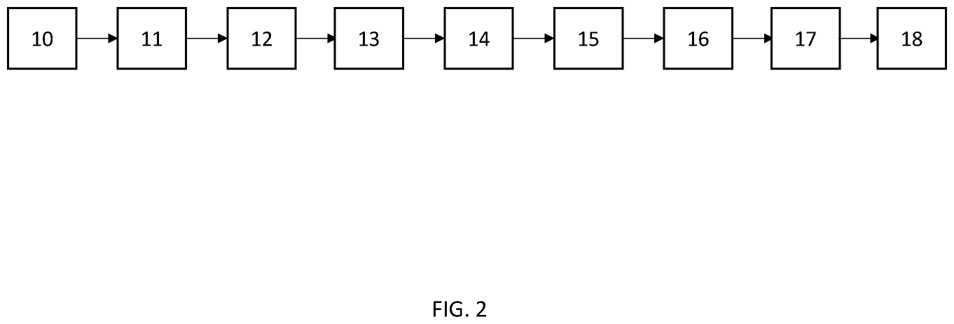

FIG. 2 shows a flow chart of an embodiment of a method for anonymizing and transforming input data to signatures, and/or for de-identification and anonymization of input data, as disclosed elsewhere herein. In this specific embodiment of the present disclosure, the method comprises a step of obtaining the input data (10). This step may for example be carried out by a system comprising an input interface or any other input means. Further, the method typically comprises a step of transforming the input data into a subset D of an ambient distance space U, which may be a subset of the set of sequences of n real numbers Rⁿ with the Euclidean distance (11). This step may for example be carried out by a processing unit. Similarly, the following steps may also be carried out by a processing unit: a step of generating a reference object, described by a dataset T, wherein the dataset T is a subset of the ambient distance space U (12); a step of generating, for each point x of the dataset D, a filter function fₓ on the reference object T (13); a step of selecting a set of distributions encoding geometrical aspects of the reference object T (14); a step of sampling, for each point x of the dataset D, a predetermined number of sample points of the dataset T according to probabilities given by the values of the selected distribution(s) evaluated on the filter function fₓ (15); a step of selecting a clustering method as a base parameter for generating zero degree homology stable ranks (16); and a step of selecting a homology degree and, for each point x of the dataset D and for each distribution and clustering method, take the average associated homology stable rank which results in a sequence of stable ranks for each data point x. The method thereby results in obtaining transformed data, i.e. fully anonymous signatures of the input data. The transformed data may be a de-identified and fully anonymous representation of the dataset D (17), such as fully anonymous signatures of the input data. The transformed data may be referred to as a signature of the input data.

Optionally, the method may include a step of using said representation of the dataset (18), e.g. by providing the representation to a machine learning model. In other aspects of the present disclosure, relates to a computer program product that comprises instructions which, when the program is executed by a computer, cause the computer to carry out the steps of the above-mentioned method disclosed in FIG. 2.

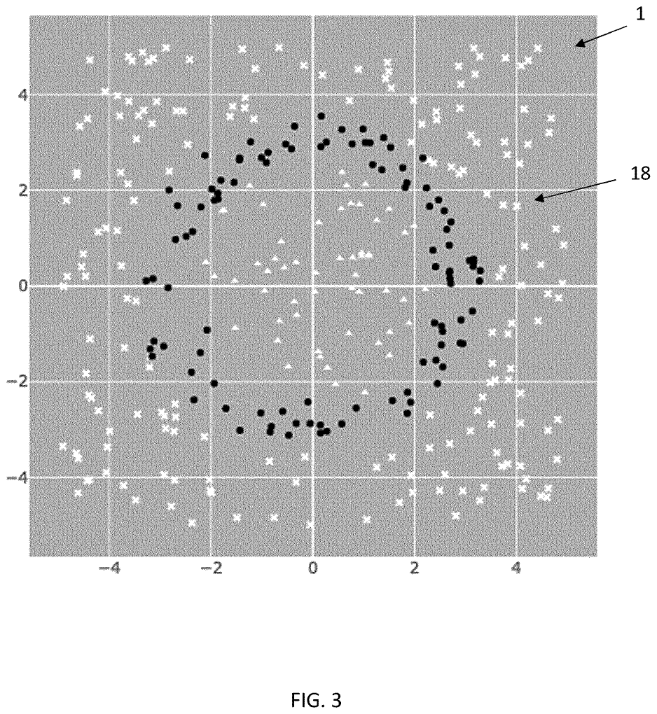

FIG. 3 shows an input dataset (1) that may be used in an embodiment of the method disclosed herein. The dataset comprises a number of data points (18) randomly sampled on a plane, and the reference object comprises points sampled from a circle with noise (black).

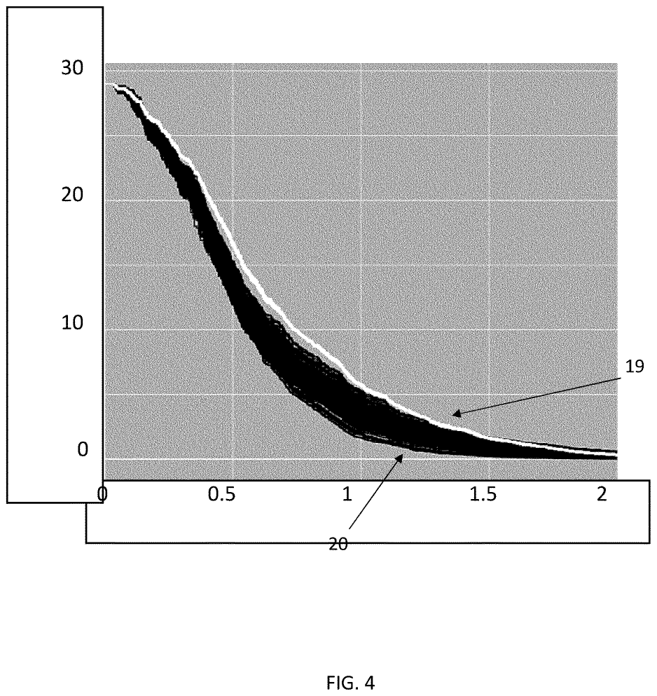

FIG. 4 shows stable ranks (19-20), also referred to as signatures, generated from the input data shown in FIG. 3, using a method according to the present disclosure. The signatures are color coded based on distance from the center of mass. In this example, the averaged signatures have been clustered into two groups, namely a first group (black, 20) corresponding to points outside the circle, and a second group (white, 19) corresponding to points inside the circle. Hereafter, the output data may be used for further analysis.

### Items

1. A system configured for transforming input data, such as de-identification and anonymization of input data, the system comprising:
   an input interface configured for obtaining the input data;
   a processing unit configured for carrying out a method of de-identification and anonymization of input data, the method comprising:
      i. obtaining the input data by the input interface;
      ii. transforming the input data into a subset D of an ambient distance space U, such as into a subset of the set of sequences of n real numbers Rⁿ with the Euclidean distance;
      iii. generating a reference object, described by a dataset T, wherein the dataset T is a subset of the ambient distance space U;
      iv. generating, for each point x of the dataset D, a filter function ƒₓ on the reference object T;
      v. selecting a set of distributions encoding geometrical aspects of the reference object T;
      vi. sampling, for each point x of the dataset D, a predetermined number of sample points of the dataset T according to probabilities given by the values of the selected distribution(s) evaluated on the filter function ƒₓ;
      vii. selecting a clustering method as a base parameter for generating zero degree homology stable ranks;
      viii. selecting a homology degree and, for each point x of the dataset D and for each distribution and clustering method, take the average associated homology stable rank which results in a sequence of stable ranks for each data point x;
   thereby obtaining de-identified and/or fully anonymous representation of the dataset D.
2. The system according to item 1, wherein the dataset D comprises or consists of a collection of data points in a distance space, such as a Euclidean space Rⁿ.

3. The system according to any one of the preceding items, wherein the reference object is an internal reference object that is a subset of the dataset D.
4. The system according to item 3, wherein the internal reference object is a subset of D corresponding to a predetermined type of category of points of the data.
5. The system according to any one of the proceeding items, wherein the reference object is an external reference object, which is a subset of the ambient distance space U given by a dataset D₂, which is not a subset of D.
6. The system according to any one of the preceding items, wherein the filter function ƒₓ on the reference object T is arranged to produce a distance between a point in the reference object T and said data point x.
7. The system according to any one of the preceding items, wherein the filter function ƒₓ on the reference object is given by a geometrical projection along a vector field on the product between the dataset and the reference object.
8. The system according to any one of the preceding items, wherein the ambient distance space U is selected from the space of n sequences of real and/or complex numbers Rⁿ, such as wherein the distance is given by any one of Euclidean, Chebyshev, Minkowski, or cosine distance.
9. The system according to item 8, wherein the ambient distance space U is selected from the space of n sequences of real numbers Rⁿ, with the Euclidean distance.
10. The system according to any one of the preceding items, wherein the filter function of the internal reference object is a distance function and/or a projection function.
11. The system according to any one of the preceding items, wherein the set of distributions comprises one or more of a uniform distribution, a uniform distribution supported on a specified domain range, a normal distribution and/or any distribution including those that can be defined by a piecewise linear function and/or a combination thereof.
12. The system according to any one of the preceding items, wherein for each point x of the dataset D the sampling is obtained according to probabilities determined by each distribution, of the set of distributions, applied to the filter function ƒₓ.
13. The system according to item 12, wherein the set of distributions comprises multiple distributions, and wherein the sampling comprises a round of sampling for each distribution of the set of distributions, and wherein each round of sampling comprises, for each point x of the dataset D, sampling of the reference object by choosing its points according to the probabilities determined by each respective distribution applied to the filter function ƒₓ.
14. The system according to any one of the preceding items, wherein the sampling enables averaging of the resultant stable ranks, thereby decreasing deviation and extracting more relevant and statistically useful geometrical information.
15. The system according to any one of the preceding items, wherein each data point of the dataset D is encoded by its geometrical properties via the generated average stable ranks.
16. The system according to any one of the preceding items, wherein the coordinates of the point(s) of the original dataset D cannot be retrieved from the obtained stable ranks.
17. A computer implemented method for transforming data, such as de-identification and anonymization of data, and subsequent analysis, the method comprising:
   i. obtaining the input data;
   ii. transforming the input data into a subset D of an ambient distance space U, such as into a subset of the set of sequences of n real numbers Rⁿ with the Euclidean distance;
   iii. generating a reference object, described by a dataset T, wherein the dataset T is a subset of the ambient distance space U;
   iv. generating, for each point x of the dataset D, a filter function ƒₓ on the reference object T;
   v. selecting a set of distributions encoding geometrical aspects of the reference object T;
   vi. sampling, for each point x of the dataset D, a predetermined number of sample points of the dataset T according to probabilities given by the values of the selected distribution(s) evaluated on the filter function ƒₓ;
   vii. selecting a clustering method as a base parameter for generating zero degree homology stable ranks;
   viii. selecting a homology degree and, for each point x of the dataset D and for each distribution and clustering method, take the average associated homology stable rank which results in a sequence of stable ranks for each data point x;
   thereby obtaining transformed data, such as a de-identified and fully anonymous representation of the dataset D.
18. The method of item 17, further comprising a step of providing the obtained de-identified and anonymized data to a machine learning model.
19. The method of item 18, further comprising a step of providing a secondary step of using the output data with a machine learning model, and wherein the machine learning model is configured for comparison of the de-identified and anonymized data.
20. The method according to any one of items 17-19, wherein the dataset D comprises or consists of a collection of data points in a distance space, such as a Euclidean space Rⁿ.
21. The method according to any one of items 17-20, wherein the reference object is an internal reference object that is a subset of the dataset D.
22. The method according to item 21, wherein the internal reference object is a subset of D corresponding to a predetermined type of category of data.
23. The method according to item 22, wherein the category of data for the reference object selection may be selected from some group which may include some clinical observation(s) and/or some other observation from the data.
24. The method according to any one of items 17-23, wherein the reference object is an external reference object, which is a subset of the ambient distance space U given by a dataset D₂, which is not a subset of D.
25. The method according to any one of items 17-24, wherein the filter function ƒₓ on the reference object is given by a geometrical projection along a vector field on the product between the dataset and the reference object.
26. The method according to any one of items 17-25, wherein the ambient distance space U is selected from the space of n sequences of real, and/or complex, numbers Rⁿ, such as wherein the distance is given by any one of Euclidean, Chebyshev, Minkowski, cosine, or some other distance.
27. The method according to any one of items 17-26, wherein the ambient distance space U is selected from the space of n sequences of real numbers Rⁿ with the Euclidean distance.
28. The method according to any one of items 17-27, wherein the filter function of the reference object is given by the distances to the considered data point.
29. The method according to any one of items 17-28, wherein the filter function of the internal reference object is a distance function.
30. The method according to any one of items 17-29, wherein the set of distributions comprises one or more of a uniform distribution, a uniform distribution supported on a specified domain range, a normal distribution and/or any distribution including those that can be defined by a piecewise linear function and/or a combination thereof.
31. The method according to any one of items 17-30, wherein for each point x of the dataset D the sampling is obtained according to probabilities determined by each distribution, of the set of distributions, applied to the filter function ƒₓ.
32. The method according to item 31, wherein the set of distributions comprises multiple distributions, and wherein the sampling comprises a round of sampling for each distribution of the set of distributions, and wherein each round of sampling comprises, for each point x of the dataset D, sampling by obtaining data points according to the probabilities determined by each respective distribution applied to the filter function ƒₓ.
33. The method according to any one of items 17-32, wherein the sampling enables averaging of the resultant stable ranks, thereby decreasing deviation and extracting more relevant and statistically useful geometrical information.
34. The method according to any one of items 17-33, wherein each data point of the dataset D is encoded by its geometrical properties via the generated average stable ranks.
35. The method according to any one of items 17-34, wherein the coordinates of the point(s) of the original dataset D cannot be retrieved from the obtained stable ranks.
36. A computer program product that comprises instructions which, when the program is executed by a computer, cause the computer to carry out the steps of the method of items 17-35.

### Objects

1. A system configured for anonymizing and transforming input data into signatures, the system comprising:
   an input interface configured for obtaining the input data;
   a processing unit configured for carrying out a method of anonymizing and transforming input data to signatures, the method comprising:
      i. obtaining the input data by the input interface;
      ii. transforming the input data into a subset D of an ambient distance space U, such as into a subset of the set of sequences of n real numbers Rⁿ with the Euclidean distance;
      iii. generating a reference object, described by a dataset T, wherein the dataset T is a subset of the ambient distance space U;
      iv. generating, for each point x of the dataset D, a filter function ƒₓ on the reference object T;
      v. selecting a set of distributions encoding geometrical aspects of the reference object T;
      vi. sampling, for each point x of the dataset D, a predetermined number of sample points of the dataset T according to probabilities given by the values of the selected distribution(s) evaluated on the filter function ƒₓ;
      vii. selecting a clustering method as a base parameter for generating zero degree homology stable ranks;
      viii. selecting a homology degree and, for each point x of the dataset D and for each distribution and clustering method, take the average associated homology stable rank which results in a sequence of stable ranks for each data point x;
   thereby obtaining fully anonymous signatures of the input data.
2. The system according to object 1, wherein the system is configured for de-identification and anonymization of the input data, and/or wherein the transformed data is a de-identified and/or fully anonymous representation of the dataset D.
3. The system according to any one of the preceding objects, wherein the input data comprises biological data, medical data and/or financial data.
4. The system according to any one of the preceding objects, wherein the dataset D comprises or consists of a collection of data points in a distance space, such as a Euclidean space Rⁿ.
5. The system according to any one of the preceding objects, wherein the reference object is an internal reference object that is a subset of the dataset D.
6. The system according to object 5, wherein the internal reference object is a subset of D corresponding to a predetermined type of category of points of the data.
7. The system according to any one of the proceeding objects, wherein the reference object is an external reference object, which is a subset of the ambient distance space U given by a dataset D₂, which is not a subset of D.
8. The system according to any one of the preceding objects, wherein the filter function ƒₓ on the reference object T is arranged to produce a distance between a point in the reference object T and said data point x.
9. The system according to any one of the preceding objects, wherein the filter function ƒₓ on the reference object is given by a geometrical projection along a vector field on the product between the dataset and the reference object.
10. The system according to any one of the preceding objects, wherein the ambient distance space U is selected from the space of n sequences of real and/or complex numbers Rⁿ, such as wherein the distance is given by any one of Euclidean, Chebyshev, Minkowski, or cosine distance.
11. The system according to object 10, wherein the ambient distance space U is selected from the space of n sequences of real numbers Rⁿ, with the Euclidean distance.
12. The system according to any one of the preceding objects, wherein the filter function of the internal reference object is a distance function and/or a projection function.
13. The system according to any one of the preceding objects, wherein the set of distributions comprises one or more of a uniform distribution, a uniform distribution supported on a specified domain range, a normal distribution and/or any distribution including those that can be defined by a piecewise linear function and/or a combination thereof.
14. The system according to any one of the preceding objects, wherein for each point x of the dataset D the sampling is obtained according to probabilities determined by each distribution, of the set of distributions, applied to the filter function ƒₓ.
15. The system according to object 14, wherein the set of distributions comprises multiple distributions, and wherein the sampling comprises a round of sampling for each distribution of the set of distributions, and wherein each round of sampling comprises, for each point x of the dataset D, sampling of the reference object by choosing its points according to the probabilities determined by each respective distribution applied to the filter function ƒₓ.
16. The system according to any one of the preceding objects, wherein the sampling enables averaging of the resultant stable ranks, thereby decreasing deviation and extracting more relevant and statistically useful geometrical information.
17. The system according to any one of the preceding objects, wherein each data point of the dataset D is encoded by its geometrical properties via the generated average stable ranks.
18. The system according to any one of the preceding objects, wherein the coordinates of the point(s) of the original dataset D cannot be retrieved from the obtained stable ranks.
19. A computer implemented method of anonymizing and transforming input data to signatures, the method comprising:
   i. obtaining the input data;
   ii. transforming the input data into a subset D of an ambient distance space U, such as into a subset of the set of sequences of n real numbers Rⁿ with the Euclidean distance;
   iii. generating a reference object, described by a dataset T, wherein the dataset T is a subset of the ambient distance space U;
   iv. generating, for each point x of the dataset D, a filter function ƒₓ on the reference object T;
   v. selecting a set of distributions encoding geometrical aspects of the reference object T;
   vi. sampling, for each point x of the dataset D, a predetermined number of sample points of the dataset T according to probabilities given by the values of the selected distribution(s) evaluated on the filter function ƒₓ;
   vii. selecting a clustering method as a base parameter for generating zero degree homology stable ranks;
   viii. selecting a homology degree and, for each point x of the dataset D and for each distribution and clustering method, take the average associated homology stable rank which results in a sequence of stable ranks for each data point x;
   thereby obtaining fully anonymous signatures of the input data.
20. The method of object 19, further comprising a step of providing the signatures, such as the obtained de-identified and anonymized data, to a machine learning model.
21. The method of object 20, further comprising a step of using the signatures with a machine learning model, and wherein the machine learning model is configured for comparison of the signatures, such as the de-identified and anonymized data.
22. The method according to any one of objects 19-21, wherein the dataset D comprises or consists of a collection of data points in a distance space, such as a Euclidean space Rⁿ.
23. The method according to any one of objects 19-22, wherein the reference object is an internal reference object that is a subset of the dataset D.
24. The method according to object 23, wherein the internal reference object is a subset of D corresponding to a predetermined type of category of data.
25. The method according to object 24, wherein the category of data for the reference object selection may be selected from some group which may include some clinical observation(s) and/or some other observation from the data.
26. The method according to any one of objects 19-25, wherein the reference object is an external reference object, which is a subset of the ambient distance space U given by a dataset D₂, which is not a subset of D.
27. The method according to any one of objects 19-26, wherein the filter function ƒₓon the reference object is given by a geometrical projection along a vector field on the product between the dataset and the reference object.
28. The method according to any one of objects 19-27, wherein the ambient distance space U is selected from the space of n sequences of real, and/or complex, numbers Rⁿ, such as wherein the distance is given by any one of Euclidean, Chebyshev, Minkowski, cosine, or some other distance.
29. The method according to any one of objects 19-28, wherein the ambient distance space U is selected from the space of n sequences of real numbers Rⁿ with the Euclidean distance.
30. The method according to any one of objects 19-29, wherein the filter function of the reference object is given by the distances to the considered data point.
31. The method according to any one of objects 19-30, wherein the filter function of the internal reference object is a distance function.
32. The method according to any one of objects 19-31, wherein the set of distributions comprises one or more of a uniform distribution, a uniform distribution supported on a specified domain range, a normal distribution and/or any distribution including those that can be defined by a piecewise linear function and/or a combination thereof.
33. The method according to any one of objects 19-32, wherein for each point x of the dataset D the sampling is obtained according to probabilities determined by each distribution, of the set of distributions, applied to the filter function ƒₓ.
34. The method according to object 33, wherein the set of distributions comprises multiple distributions, and wherein the sampling comprises a round of sampling for each distribution of the set of distributions, and wherein each round of sampling comprises, for each point x of the dataset D, sampling by obtaining data points according to the probabilities determined by each respective distribution applied to the filter function ƒₓ.
35. The method according to any one of objects 19-34, wherein the sampling enables averaging of the resultant stable ranks, thereby decreasing deviation and extracting more relevant and statistically useful geometrical information.
36. The method according to any one of objects 19-35, wherein each data point of the dataset D is encoded by its geometrical properties via the generated average stable ranks.
37. The method according to any one of objects 19-36, wherein the coordinates of the point(s) of the original dataset D cannot be retrieved from the obtained stable ranks.

A computer program product that comprises instructions which, when the program is executed by a computer, cause the computer to carry out the steps of the method of objects 19-37.

1-19. (canceled)

20. A computer-implemented method for anonymizing and transforming input data into signatures, the method comprising:
obtaining the input data;
transforming the input data into a subset D of an ambient distance space U;
generating a reference object, described by a dataset T, wherein the dataset T is a subset of the ambient distance space U;
generating, for each point x in the dataset D, a filter function fx on the reference object T;
selecting at least one probability distribution that defines geometrical aspects of the reference object T;
sampling, for each point x in the dataset D, a predetermined number of sample points from the dataset T according to probabilities given by the selected probability distribution(s) evaluated on the filter function fx;
selecting a clustering method as a base parameter for generating zero-degree homology stable ranks, wherein the clustering method groups the sampled points based on geometric relationships;
selecting a homology degree and, for each point x of the dataset D and for each probability distribution and clustering method, computing an average associated homology stable rank, thereby generating a sequence of stable ranks for each data point x; and
outputting the sequence of stable ranks as one or more anonymized signatures of the input data, wherein the one or more anonymized signatures retain geometric properties of the dataset D while being non-invertible and preventing reconstruction of the original data.

21. The method of claim 20, wherein the input data comprises biological data, medical data, insurance data, financial data, banking data, industrial data, advertising data, or personal data.

22. The method of claim 20, wherein the reference object is an internal reference object that is a subset of the dataset D.

23. The method of claim 22, wherein the internal reference object is a subset of D corresponding to a predetermined type of category of points of the data.

24. The method of claim 20, wherein the reference object is an external reference object that is a subset of the ambient distance space U and is not a subset of dataset D.

25. The method of claim 20, wherein the filter function fₓ on the reference object T produces a distance between a point in the reference object T and the data point x.

26. The method of claim 20, wherein the filter function fₓ is a geometrical projection along a vector field on the product between the dataset D and the reference object T.

27. The method of claim 20, wherein the ambient distance space U is a space of n sequences of real or complex numbers Rₙ, wherein the distance is measured according to Euclidean, Chebyshev, Minkowski, or cosine distance.

28. The method of claim 27, wherein the ambient distance space U is a space of n sequences of real numbers Rn, using Euclidean distance.

29. The method of claim 20, wherein the at least one probability distribution is selected from a uniform distribution, a uniform distribution restricted to a domain range, a normal distribution, or a piecewise linear function-based distribution.

30. The method of claim 20, wherein each data point in the dataset D is encoded by its geometrical properties via the computed stable ranks.

31. The method of claim 20, wherein the stable ranks generated for each data point are used for comparative analysis across multiple anonymized datasets.

32. The method of claim 20, wherein the number of sample points from dataset T selected for each point x of dataset D is dynamically adjusted based on statistical measures of dataset variation.

33. The method of claim 20, wherein the anonymized signatures are stored in a database for future comparison and analysis.

34. The method of claim 20, further comprising applying a machine learning model to the anonymized signatures to detect patterns or correlations in the transformed data.

35. The method of claim 34, wherein the machine learning model applies a clustering algorithm to the anonymized signatures.

36. The method of claim 34, wherein the machine learning model applies a classification model trained on previously labeled anonymized signatures.

37. The method of claim 20, wherein the anonymized signatures are used for fraud detection by comparing newly generated signatures against a database of known fraudulent data patterns.

38. The method of claim 20, wherein the anonymized signatures are compared to a historical dataset to identify trends in anonymized data over time.

39. The method of claim 20, wherein the anonymized signatures are used to construct privacy-preserving collaborative datasets across multiple institutions without requiring data sharing.
